(19) United States
(12) Patent Application Publication
(10) Pub. No.: US 2024/0118151 A1
(43) Pub. Date: Apr. 11, 2024

(54) SENSING DATA CORRECTION SYSTEM AND SENSING DATA CORRECTION METHOD

(71) Applicant: Hitachi, Ltd., Tokyo (JP)

(72) Inventors: Hiroyuki YOSHIMOTO, Tokyo (JP); Yu YAMADA, Tokyo (JP)

(21) Appl. No.: 18/376,121

(22) Filed: Oct. 3, 2023

(30) Foreign Application Priority Data
Oct. 6, 2022 (JP) 2022-161783

(51) Int. Cl. G01L 5/00; G01L 1/20

(52) U.S. Cl. CPC G01L 5/0028; G01L 1/20

(57) ABSTRACT

A sensing data correction system corrects sensing data acquired from a glove-type wearable sensor in which a film-like pressure sensor is incorporated into a fingertip, and includes a data correction unit for correcting the sensing data. Three coordinate axis directions in a three-dimensional orthogonal coordinate system are assumed to be a vertical direction, a longitudinal direction of the pressure sensor, and a width direction of the pressure sensor, and the pressure sensor is obtained by laminating one flexible printed circuit, one sheet-like pressure sensitive element, and one protective film in the vertical direction. An upper surface of the flexible printed circuit and a lower surface of the pressure sensitive element are bonded and fixed to each other, and an upper surface of the pressure sensitive element and a lower surface of the protective film are bonded and fixed to each other. The data correction unit executes sensing data correction processing.

### CROSS-REFERENCE TO RELATED APPLICATION

The present application claims priority from Japanese application JP2022-161783, filed on Oct. 6, 2022, the content of which is hereby incorporated by reference into this application.

### BACKGROUND OF THE INVENTION

### 1. Field of the Invention

The present invention relates to a technique for correcting sensing data.

### 2. Description of the Related Art

In a manufacturing site of today where the automation of production lines has been advanced, there are still quite a few work processes that require human labor. In the work processes that require human labor, there are problems such as the retirement of skilled workers and the resulting shortage of successors, in addition to chronic labor shortages caused by a decline in the working-age population. As part of efforts to solve such problems, in recent years, the action of skilled workers during work has been digitized to be used as teaching materials in vocational training for the development of successors or used as a standard to check whether or not the work is accurate.

One of the main methods for digitizing the action of people who are working is a method in which various wearable sensors are mounted on a worker to directly sense the action of the worker. As an example, when digitizing various manual works including an action of grasping and releasing an object, a method of using a glove-type wearable sensor in which a film-like or sheet-like pressure sensor is incorporated into a fingertip of a work glove has been known as an effective method (for example, JP-2021-001410-A).

### SUMMARY OF THE INVENTION

In an actual manufacturing site, it is very important that the glove-type wearable sensor worn by a worker have a good wearing feeling fitting well to the tip of a hand and not hindering the action, so as not to interfere with the work. Therefore, it is preferable for the glove-type wearable sensor provided for the above-described applications to have a film-like or sheet-like (hereinafter, simply and correctively referred to as “film-like”) pressure sensor incorporated into a fingertip of a thin work glove.

However, in a case where such wearable sensors are created using thin work gloves in order to obtain a good wearing feeling, there is a problem that, at the beginning of wearing of the wearable sensor, various stresses act on a pressure sensitive element inside a pressure sensor to thereby cause the pressure sensor to react and unnecessary sensor values are acquired.

In view of the above problem, an object of the present invention is to provide a technique capable of correcting sensing data acquired from a glove-type wearable sensor in which a film-like pressure sensor is incorporated into a fingertip of a thin work glove into sensing data that accurately reflects only the pressure to be truly detected.

A sensing data correction system according to the present invention is a sensing data correction system that corrects sensing data acquired from a glove-type wearable sensor in which a film-like pressure sensor is incorporated into a fingertip. The sensing data correction system includes a data correction unit for correcting the sensing data. Three coordinate axis directions in a three-dimensional orthogonal coordinate system are assumed to be a vertical direction, a longitudinal direction of the pressure sensor, and a width direction of the pressure sensor. The pressure sensor is obtained by laminating one flexible printed circuit, one sheet-like pressure sensitive element, and one protective film in the vertical direction. An upper surface of the flexible printed circuit and a lower surface of the pressure sensitive element are bonded and fixed to each other, and an upper surface of the pressure sensitive element and a lower surface of the protective film are bonded and fixed to each other. The data correction unit executes sensing data correction processing to correct the sensing data acquired from the wearable sensor at a beginning of wearing of the wearable sensor.

The other problems and solving methods disclosed in this application will be clarified by the description in the column of the description of the preferred embodiment and the drawings.

According to the present invention, the sensing data acquired from the glove-type wearable sensor in which the film-like pressure sensor is incorporated into the fingertip of the thin work glove can be corrected into the sensing data that accurately reflects only the pressure to be truly detected.

### BRIEF DESCRIPTION OF THE DRAWINGS

FIG. 1 shows the appearance of a wearable sensor according to an embodiment;

FIG. 2 shows a configuration example of a pressure sensor according to the embodiment;

FIG. 3 shows a configuration example of a flexible printed circuit of the pressure sensor according to the embodiment;

FIG. 4 schematically shows a state when the pressure sensor according to the embodiment is deformed;

FIG. 5 shows a configuration example of a sensing data correction system according to the embodiment; and

FIG. 6 shows an example of a flow of sensing data correction processing performed in the embodiment.

### DESCRIPTION OF THE PREFERRED EMBODIMENT

In the following description, an “interface device” may be one or more interface devices. The one or more interface devices may be at least one of the followings.
One or more input/output (I/O) interface devices

The I/O interface device is an interface device for at least one of an I/O device and a remote display computer. The I/O interface device for the display computer may be a communication interface device. At least one I/O device may be either a user interface device, for example, an input device such as a keyboard and a pointing device, or an output device such as a display device.
One or more communication interface devices

The one or more communication interface devices may be one or more communication interface devices (for example, one or more network interface cards (NICs)) of the same kind or two or more communication interface devices (for example, an NIC and a host bus adapter (HBA)) of different kinds.

In addition, in the following description, a “memory” is one or more memory devices that are examples of one or more storage devices, and may typically be a main storage device. At least one memory device in the memory may be a volatile memory device or a non-volatile memory device.

In addition, in the following description, a “permanent storage device” may be one or more permanent storage devices that are examples of one or more storage devices. The permanent storage device may typically be a non-volatile storage device (for example, an auxiliary storage device), specifically, for example, a hard disk drive (HDD), a solid state drive (SSD), a non-volatile memory express (NVME) drive, or a storage class memory (SCM).

In addition, in the following description, a “storage device” may be a memory and at least a memory of a permanent storage device.

In addition, in the following description, a “processor” may be one or more processor devices. At least one processor device may typically be a microprocessor device such as a central processing unit (CPU), but may be another kind of processor device such as a graphics processing unit (GPU). At least one processor device may be single-core or multi-core. At least one processor device may be a processor core. At least one processor device may be a processor device in a broad sense such as a circuit (for example, a field-programmable gate array (FPGA), a complex programmable logic device (CPLD), or an application specific integrated circuit (ASIC)) that is a collection of gate arrays with a hardware description language that performs some or all of processing.

In addition, in the following description, a function will be described with the expression of “yyy unit” in some cases, but the function may be realized by one or more computer programs being executed by a processor, by one or more hardware circuits (for example, an FPGA or an ASIC), or by a combination thereof. In the case where a function is realized by a program being executed by a processor, the function may be at least a part of the processor because the prescribed processing is performed by using a storage device and/or an interface device as appropriate. Processing described with a function as the subject may be processing performed by a processor or a device having the processor. A program may be installed from a program source. The program source may be, for example, a program distribution computer or a computer-readable recording medium (for example, a non-temporary recording medium). The description of each function is an example, and a plurality of functions may be combined into one function, or one function may be divided into a plurality of functions.

In addition, in the following description, processing will be described with a “program” as the subject in some cases, but the processing described with a program as the subject may be processing performed by a processor or a device having the processor. In addition, two or more programs may be realized as one program, or one program may be realized as two or more programs.

In addition, in the following description, information from which an output can be obtained for an input will be described in some cases with such an expression as an “xxx table,” but the information may be a table having any structure, or a learning model represented by a neural network, a genetic algorithm, or a random forest that generates an output for an input. Therefore, the “xxx table” can be referred to as “xxx information.” In addition, in the following description, the configuration of each table is an example, one table may be divided into two or more tables, or all or a part of two or more tables may be one table.

In addition, in the following description, “UI” is an abbreviation for “user interface,” but is typically a graphical user interface (GUI).

In addition, in the following description, a system for correcting sensing data acquired by a glove-type wearable sensor will be referred to as a “sensing data correction system.” The sensing data correction system may be one or more physical computers, a software-defined system realized by at least one physical computer executing predetermined software, or a system realized on a cloud infrastructure (typically, a plurality of kinds of computing resources including a processor and a storage device). For example, in the case where a computer has a display device and the computer displays information on its own display device, the computer may be a sensing data correction system. In addition, for example, in the case where a first computer (for example, a server) transmits output information to a remote second computer (a display computer (for example, a user terminal to be described later)) and the display computer displays the information (in the case where the first computer displays the information on the second computer), at least the first computer among the first computer and the second computer may be a sensing data correction system. That is, “to display the output information” by the sensing data correction system may be to display the output information on the display device included in the computer, or to transmit the output information to the display computer by the computer (in the latter case, the output information is displayed by the display computer).

Hereinafter, the present embodiment will be described in detail.

It should be noted that the following description assumes that three coordinate axis directions in a three-dimensional orthogonal coordinate system are a vertical direction, a longitudinal direction of a pressure sensor, and a width direction of the pressure sensor.

First, the outline of a wearable sensor will be described.

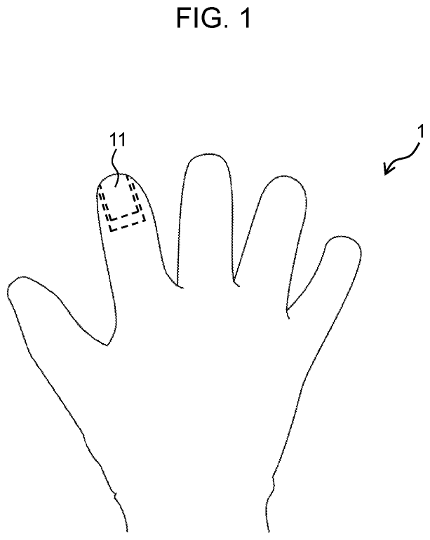

FIG. 1 shows the appearance of a wearable sensor 1 according to the embodiment.

As shown in FIG. 1, the wearable sensor 1 is a glove-type wearable sensor that is also referred to as a sensor glove or a sensor-incorporated glove and in which a film-like pressure sensor 11 is incorporated into a fingertip of a thin work glove. The pressure sensor 11 is incorporated into the center region on the cushion side of the fingertip of the wearable sensor 1, and when the wearable sensor 1 is mounted on a hand of a wearer, the shape thereof is deformed along the shape of the fingertip of the wearer. Accordingly, the wearable sensor 1 fits well to the tip of the hand of the wearer. As a result, the wearer of the wearable sensor 1 can obtain a good wearing feeling that does not hinder work even in an actual manufacturing site.

In addition, since the pressure sensor 11 incorporated into the fingertip is provided with features to be described later, the wearable sensor 1 can properly detect a pressure applied to the fingertip of the wearer of the wearable sensor 1.

That is, the wearable sensor 1 provided with the above features fits well to the tip of the hand of the wearer and can accurately detect the application of pressure to the fingertip of the wearer.

It should be noted that, although the wearable sensor 1 exemplified in FIG. 1 is illustrated on the assumption that the pressure sensor 11 is incorporated into the fingertip of the index finger, to facilitate understanding, it is obvious that the pressure sensor 11 may be incorporated into the fingertip of another finger or into the fingertips of a plurality of fingers. In addition, it is sufficient if the specific position and orientation of the pressure sensor 11 incorporated into the fingertip of the wearable sensor 1 are appropriately determined according to the details of the action of the wearer during the work and the physical features of the wearer.

Next, a pressure sensor incorporated into the wearable sensor 1 will be described.

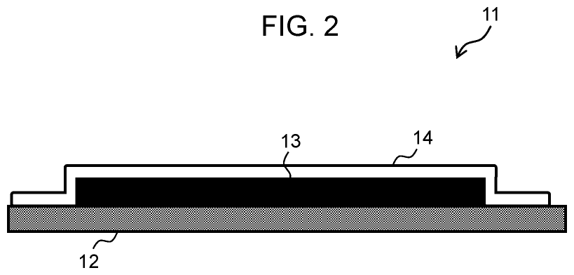

FIG. 2 shows a configuration example of the pressure sensor 11 according to the embodiment.

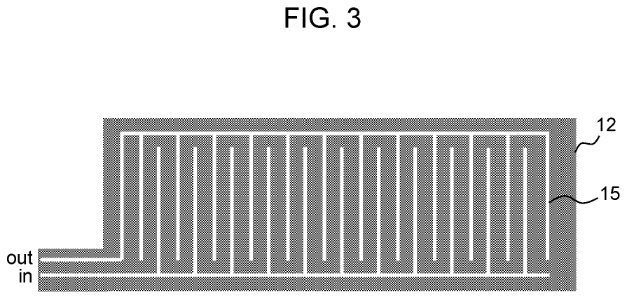

In addition, FIG. 3 shows a configuration example of a flexible printed circuit 12 of the pressure sensor 11 according to the embodiment.

The pressure sensor 11 shown in FIG. 2 includes one flexible printed circuit 12, one pressure sensitive element 13, and one protective film 14. As shown in FIG. 3, in the flexible printed circuit 12, a sheet-like electrode 15 made of a conductive metal foil such as a copper foil is provided inside a polymer thick film (PTF). As shown in FIG. 3, the electrode 15 provided in the flexible printed circuit 12 is formed approximately in a comb-like shape when viewed from the vertical direction. On the upper surface side of the flexible printed circuit 12, the sheet-like pressure sensitive element 13 is provided approximately parallel to the flexible printed circuit 12. The pressure sensitive element 13 is electrically connected to the electrode 15 of the flexible printed circuit 12. Then, on the upper surface side of the pressure sensitive element 13, the protective film 14 made of insulating resin is arranged, and an upper surface of the flexible printed circuit 12 and a lower surface of the protective film 14 are bonded and fixed to each other at the periphery of the pressure sensor 11.

That is, the pressure sensitive element 13 is enclosed in an inner space of the pressure sensor 11, the inner space being formed by the upper surface of the flexible printed circuit 12 and the lower surface of the protective film 14, in a position where a lower surface of the pressure sensitive element 13 faces the upper surface of the flexible printed circuit 12 and an upper surface of the pressure sensitive element 13 faces the lower surface of the protective film 14. Then, the lower surface of the pressure sensitive element 13 and the upper surface of the flexible printed circuit 12 are bonded and fixed to each other, and the upper surface of the pressure sensitive element 13 and the lower surface of the protective film 14 are bonded and fixed to each other.

When various pressures are applied to the fingertip of the wearable sensor 1 into which the pressure sensor 11 is incorporated, the pressure sensor 11 is deformed, and the pressure sensitive element 13 inside the pressure sensor 11 is accordingly deformed as well. Inside the pressure sensitive element 13, fine particles having conductivity uniformly exist at approximately equal intervals in a state where the wearable sensor 1 is not worn, that is, in an initial state. However, when the pressure sensitive element 13 is deformed, the distance between the fine particles existing inside is partially expanded and contracted. Therefore, an electrical resistance value in the pressure sensitive element 13 changes when being energized. Accordingly, the wearable sensor 1 can detect various pressures applied to the fingertip.

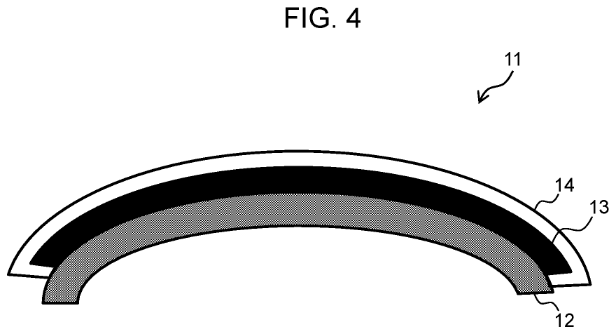

In the pressure sensor 11, the lower surface of the pressure sensitive element 13 and the upper surface of the flexible printed circuit 12 are bonded and fixed to each other, and the upper surface of the pressure sensitive element 13 and the lower surface of the protective film 14 are bonded and fixed to each other, as described above. Therefore, when the pressure sensor 11 is deformed such that both ends in a longitudinal direction bend downward as exemplified in FIG. 4, not only (1) the stress acting on the pressure sensitive element 13 itself when deformed, but also (2) the stress applied from the protective film 14 and (3) the stress applied from the flexible printed circuit 12 act on the pressure sensitive element 13 due to the difference in physical and mechanical properties of the flexible printed circuit 12, the pressure sensitive element 13, and the protective film 14. Accordingly, the pressure detected by the pressure sensor is any one of (1) to (3) of the above or a combination of (1) to (3) of the above in the initial state where correction processing is not performed. Due to the presence of such problems, the pressure sensor 11 cannot emit a sensor signal that accurately reflects only the pressure to be truly detected, at the time of wearing of the wearable sensor 1 or shortly after wearing.

Thus, a sensing data correction system 100 of the present embodiment executes correction processing on data (hereinafter, referred to as “sensing data”) representing a sensor value acquired by the pressure sensor 11. This processing executed by the sensing data correction system 100 is referred to as sensing data correction processing. Accordingly, at the time of wearing of the wearable sensor 1, it is possible to remove the influence of the unnecessary stress acting on the pressure sensitive element 13 in relation to the flexible printed circuit 12 and the protective film 14 in the pressure sensor 11.

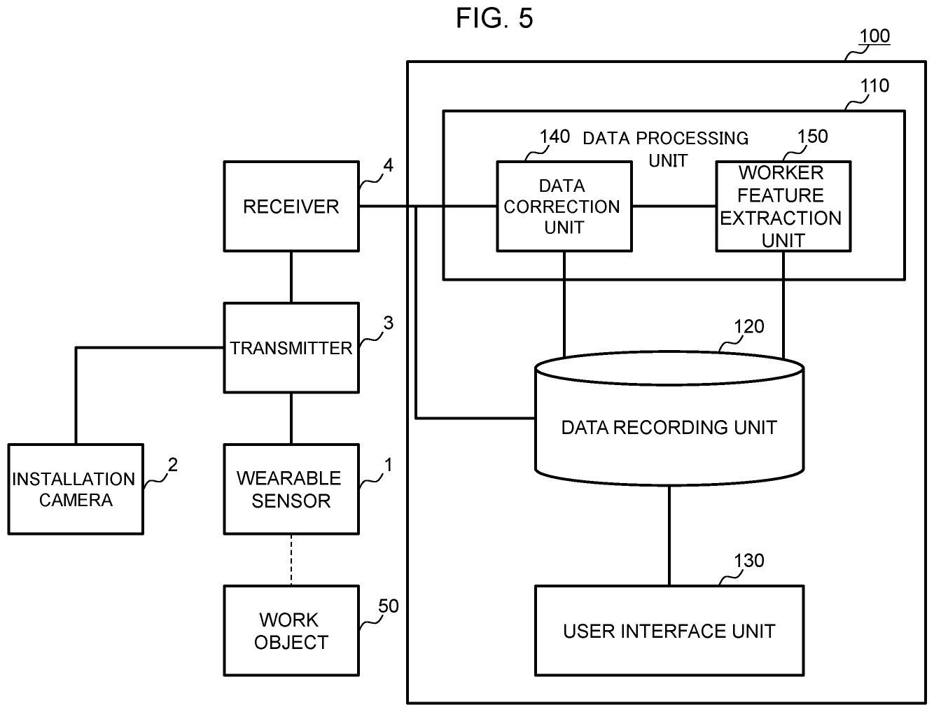

FIG. 5 shows a configuration example of the sensing data correction system 100 according to the embodiment.

Each constitutional element of the system 100 shown in FIG. 5 is realized by hardware including a processor device (hereinafter, also simply referred to as a “processor”) such as a central processing unit (CPU) and various co-processors, a storage device such as a memory and a storage, and a wired or wireless communication line and an interface device connecting them, and by software that is stored in the storage device and that supplies a processing command to an operation unit.

The storage device stores at least a sensing data correction program. The sensing data correction program is a computer program for correcting the sensing data. When the sensing data correction program is executed by the processor, each processing, to be described later, for correcting the sensing data is performed.

It should be noted that the sensing data correction program may include a device driver, an operating system, various application programs located on the upper layer of these, and a library for providing a common function to these programs. Each block described below shows not a configuration in hardware units, but a block in functional units.

The sensing data correction system 100 has each functional block of a data processing unit 110, a data recording unit 120, a user interface unit 130, and a communication unit (not shown).

The data processing unit 110 executes various kinds of data processing on the basis of operation inputs of a user detected by the user interface unit 130, data acquired by the communication unit, and programs and data stored by the data recording unit 120. The data processing unit 110 also functions as an interface for the user interface unit 130, the communication unit, and the data recording unit 120.

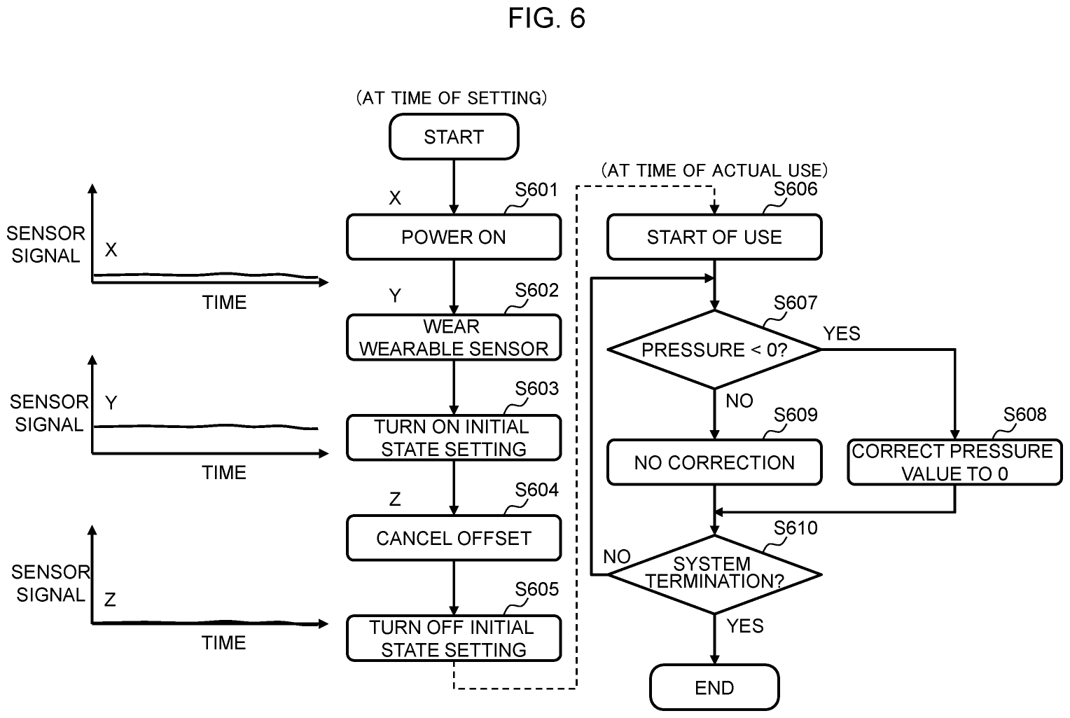

The data processing unit 110 has a data correction unit 140 as a functional block. The data correction unit 140 executes various kinds of processing for correcting the sensing data. This processing executed by the data correction unit 140 is referred to as sensing data correction processing. The details of the sensing data correction processing will be described later with reference to FIG. 6.

In addition, the data processing unit 110 may have, as a functional block, a worker feature extraction unit 150 that executes various kinds of processing for extracting the features of the wearer of the wearable sensor 1, that is, the worker. Accordingly, the sensing data correction system 100 may extract the operational features, the physical features, and the like (hereinafter, referred to as “worker features”) of each worker who is the wearer of the wearable sensor 1. The data recording unit 120 may record, in the storage device, data (hereafter, referred to as “worker feature data”) representing the worker features for each worker extracted by the worker feature extraction unit 150.

The data processing unit 110 can realize these functional blocks by executing a predetermined program.

The data recording unit 120 includes, for example, a storage device such as a random access memory (RAM) or a flash memory, and stores, in the storage device, a program for supplying various processing commands to the data processing unit 110 and data representing various pieces of information used in the processing executed by the data processing unit 110. The data processing unit 110 can realize each of the functional blocks of the data correction unit 140 and the worker feature extraction unit 150 described above, by reading and writing these pieces of information from/to the storage device.

In addition to accepting input operations from the user, the user interface unit 130 is responsible for processing related to the user interface such as image display and audio output. The user interface unit 130 has each of function blocks of an input unit (not shown) and an output unit (not shown). The input unit detects various operations from the user. The input unit includes, for example, a keyboard, a pointing device, a touch panel, and the like. The output unit causes the display device to display the sensor value represented by the sensor data, and also displays various screens on the display device and executes audio output. The display device includes, for example, a liquid crystal display, a touch screen, or the like.

The communication unit (not shown) receives the sensor data from a receiver 4 connected thereto in a wired or wireless manner, and transmits the data to the data processing unit 110 and the data recording unit 120. In addition, the communication unit is responsible for communication processing performed via the Internet (an example of communication networks) between a user terminal owned by the user of the sensing data correction system 100 and other apparatuses such as a server device. The communication unit includes, for example, an NIC, an HBA, and the like.

In the description of the present embodiment, each function of the sensing data correction system 100 is integrally realized by a single computer device. However, each of these functions may be realized by a plurality of interconnected computer devices or server devices. In addition, the sensing data correction system 100 may include a general purpose computer device such as a laptop personal computer (PC) and a web browser installed therein, or may include a web server and various portable devices.

The wearable sensor 1 is connected to a transmitter 3, and the wearable sensor 1 transmits a sensor signal representing the acquired sensor value to the transmitter 3. Upon receiving the sensor signal, the transmitter 3 transmits the sensor signal to the receiver 4. Upon receiving the sensor signal, the receiver 4 extracts the sensor data from the sensor signal and transmits the sensor data to the communication unit of the sensing data correction system 100 as described above. It should be noted that the sensor signal may be an analog signal or a digital signal. In a case where the sensor signal is an analog signal, the analog signal may be converted into a digital signal as appropriate by providing, for example, a digital-analog converter (DAC) in the receiver 4.

In addition to the wearable sensor 1, for example, an installation camera 2 for photographing an action of the worker during the work, such as an action of grasping and releasing a work object 50, may be connected to the transmitter 3 as a sensor. In this case, the sensing data correction system 100 may be capable of handling video data acquired by the installation camera 2.

Next, a flow of the sensing data correction processing executed by the sensing data correction system 100 will be described.

FIG. 6 is a flowchart for showing an example of the flow of the sensing data correction processing.

The sensing data correction processing performed in the present embodiment consists of processing (Steps S601 to S605) performed when the wearable sensor 1 is set and processing (Steps S606 to S610) performed when the wearable sensor 1 is actually used. First, a flow of processing when the wearable sensor 1 is set is as follows.

In Step S601, when the user interface unit 130 detects an input operation for activating the sensing data correction system 100, the data processing unit 110 activates the sensing data correction system 100. The relation between the sensor signal at this stage and the passage of time is as exemplified in the graph X in FIG. 6. It should be noted that, in the graphs X to Z exemplified in FIG. 6, the vertical axis shows a pressure value represented by the sensor signal, and the horizontal axis shows time. When the processing in Step S601 is completed, the data processing unit 110 proceeds to Step S602.

In Step S602, when the sensor signal emitted by the wearable sensor 1 is further lifted as shown in the graph Y in FIG. 6 due to the pressure reaction caused by the bending of the pressure sensor 11 incorporated into the fingertip of the wearable sensor 1 when the worker wears the wearable sensor 1, the data processing unit 110 acquires sensing data representing the lifted sensor signal. When the processing in Step S602 is completed, the data processing unit 110 proceeds to Step S603.

In Step S603, when the data processing unit 110 acquires the sensing data representing the sensor signal lifted as shown in the graph Y in FIG. 6, the data correction unit 140 turns on the initial state setting. Accordingly, the initial state setting of the wearable sensor 1 is turned on. It should be noted that the data correction unit 140 may turn on the initial state setting of the wearable sensor 1 in a case where the user interface unit 130 detects an input operation to turn on the initial state setting of the wearable sensor 1 without automatically turning on the initial state setting of the wearable sensor 1. When the processing in Step S603 is completed, the data processing unit 110 proceeds to Step S604.

In Step S604, the data processing unit 110 allows the data correction unit 140 to execute processing to cancel an offset. Accordingly, the offset is canceled for the sensing data representing the sensor signal lifted as shown in the graph Y in FIG. 6, and the pressure value represented by the sensing data is corrected to 0 as exemplified in the graph Z in FIG. 6. As a result, the sensing data representing the unnecessary pressure reaction caused, at the time of wearing of the wearable sensor 1, by the bending of the pressure sensor 11 incorporated into the wearable sensor 1 is appropriately corrected. When the processing in Step S604 is completed, the data processing unit 110 proceeds to Step S605.

In Step S605, when the input offset at the time of wearing of the wearable sensor 1 is canceled in Step S604, the data processing unit 110 allows the data correction unit 140 to turn off the initial state setting. Accordingly, the initial state setting of the wearable sensor 1 is turned off. It should be noted that, in a case where the initial state setting of the wearable sensor 1 is not automatically turned off and the user interface unit 130 detects an input operation to turn off the initial state setting of the wearable sensor 1, the data correction unit 140 may turn off the initial state setting of the wearable sensor 1. When the processing in Step S605 is completed, the data processing unit 110 terminates the processing related to the setting.

This is the end of the processing related to setting, and the rest is the processing related to actual use. When the processing in Step S605 is completed, the data processing unit 110 proceeds to Step S606 to perform the processing related to actual use next.

In Step S606, when the user interface unit 130 detects the start of use of the wearable sensor 1, the data processing unit 110 shifts to the processing related to actual use. When the processing in Step S606 is completed, the data processing unit 110 proceeds to Step S607.

In Step S607, the data processing unit 110 allows the data correction unit 140 to execute processing to determine whether or not the pressure value acquired by the wearable sensor 1 is less than 0. In a case where it is determined that the pressure value is less than 0 (Step S607: Y), the processing proceeds to Step S608 to correct the sensing data representing the pressure value, and in a case where it is determined that the pressure value is equal to or more than 0 (Step S607: N), the processing proceeds to Step S609.

In Step S608, the data processing unit 110 allows the data correction unit 140 to correct the sensing data representing the pressure value determined to be less than 0 in Step S607. The data correction unit 140 corrects the pressure value represented by the sensing data to 0. Accordingly, it is possible to remove the influence of a decline in the signal level due to the temporary stress relaxation caused when the worker who is the wearer of the wearable sensor 1 presses down the pressure sensor 11 with a finger at the beginning of wearing of the wearable sensor 1. When the processing in Step S608 is completed, the data processing unit 110 proceeds to Step S610.

In Step S609, the data processing unit 110 proceeds to Step S610 without performing the correction processing by the data correction unit 140 for the sensing data representing the pressure value determined to be equal to or more than 0 in Step S607.

In Step S610, the data processing unit 110 executes processing to determine whether or not to terminate the sensing data correction system 100. In a case where it is determined that the sensing data correction system 100 is terminated (Step S610: Y), the sensing data correction processing shown in the flowchart of FIG. 6 is terminated. On the other hand, in a case where it is determined that the sensing data correction system 100 is not terminated (Step S610: N), the processing returns to Step S607 again to continue the sensing data correction processing.

By executing the sensing data correction processing described above, the sensing data correction system 100 of the present embodiment can remove, from the sensing data, (1) the influence of the pressure reaction caused by the bending of the pressure sensor 11 incorporated into the fingertip of the wearable sensor 1 when the worker wears the wearable sensor 1 and (2) the influence of a decline in the signal level due to the temporary stress relaxation caused when the worker who is the wearer of the wearable sensor 1 presses down the pressure sensor 11 with a finger at the beginning of wearing of the wearable sensor 1. As a result, the sensing data correction system 100 can correct the sensing data acquired from the glove-type wearable sensor in which the film-like pressure sensor is incorporated into the fingertip of the thin work glove into the sensing data that accurately reflects only the pressure to be truly detected.

It should be noted that the present invention is not limited to the above embodiment, and can be carried out using any constitutional elements without departing from the gist thereof.

The above embodiment and modified examples are only examples, and the present invention is not limited to these contents as long as the features of the invention are not impaired. In addition, although various embodiments and modified examples have been described above, the present invention is not limited to these contents. Other aspects considered within the scope of the technical idea of the invention are also included within the scope of the invention.

What is claimed is:

1. A sensing data correction system that corrects sensing data acquired from a glove-type wearable sensor in which a film-like pressure sensor is incorporated into a fingertip, the sensing data correction system comprising:
a data correction unit for correcting the sensing data,
wherein three coordinate axis directions in a three-dimensional orthogonal coordinate system are assumed to be a vertical direction, a longitudinal direction of the pressure sensor, and a width direction of the pressure sensor,
the pressure sensor is obtained by laminating one flexible printed circuit, one sheet-like pressure sensitive element, and one protective film in the vertical direction,
an upper surface of the flexible printed circuit and a lower surface of the pressure sensitive element are bonded and fixed to each other, and an upper surface of the pressure sensitive element and a lower surface of the protective film are bonded and fixed to each other, and
the data correction unit executes sensing data correction processing to correct the sensing data acquired from the wearable sensor at a beginning of wearing of the wearable sensor.

2. The sensing data correction system according to claim 1,
wherein the sensing data correction processing includes processing to cancel an offset for the sensing data acquired from the wearable sensor at a time of wearing of the wearable sensor.

3. The sensing data correction system according to claim 1,
wherein the sensing data correction processing,
in a case where a pressure value represented by the sensing data is less than 0, includes processing to correct the pressure value represented by the sensing data to 0.

4. A sensing data correction method performed by a computer to correct sensing data acquired from a glove-type wearable sensor in which a film-like pressure sensor is incorporated into a fingertip,
wherein the computer includes a data correction unit for correcting the sensing data,
three coordinate axis directions in a three-dimensional orthogonal coordinate system are assumed to be a vertical direction, a longitudinal direction of the pressure sensor, and a width direction of the pressure sensor,
the pressure sensor is obtained by laminating one flexible printed circuit, one sheet-like pressure sensitive element, and one protective film in the vertical direction,
an upper surface of the flexible printed circuit and a lower surface of the pressure sensitive element are bonded and fixed to each other, and an upper surface of the pressure sensitive element and a lower surface of the protective film are bonded and fixed to each other, and
the data correction unit executes sensing data correction processing to correct the sensing data acquired from the wearable sensor at a beginning of wearing of the wearable sensor.
